(19) United States
(12) Patent Application Publication
(10) Pub. No.: US 2004/0191589 A1
(43) Pub. Date: Sep. 30, 2004

(54) Hydrogen storage material, hydrogen storage body, hydrogen storage device, fuel cell vehicle, and method of manufacturing hydrogen storage material

(75) Inventors: Junji Katamura, Yokosuka-shi (JP); Mikio Kawai, Yokosuka-shi (JP)

Correspondence Address: FOLEY AND LARDNER, SUITE 500, 3000 K STREET NW, WASHINGTON, DC, 20007, US

(73) Assignee: NISSAN MOTOR CO., LTD.

(21) Appl. No.: 10/798,419

(22) Filed: Mar. 12, 2004

(30) Foreign Application Priority Data
Mar. 26, 2003 (JP) 2003-085515

(51) Int. Cl. H01M 8/06; C01B 31/04

(52) U.S. Cl. 429/19; 423/448; 423/445 B

(57) ABSTRACT

A hydrogen storage material of the present invention comprises a molecule including space formed with a planar sheet constituted by six-membered rings of carbon atoms. Further, in the hydrogen storage material, at least one opening is formed in the sheet. Thereby, it is possible to utilize an internal space of the hydrogen storage material, and hydrogen can be efficiently stored therein.

### BACKGROUND OF THE INVENTION

1. Field of the Invention

The present invention relates to a hydrogen storage material which

adsorbs or stores hydrogen, a hydrogen storage body, a hydrogen storage device, a fuel cell vehicle, and a method of manufacturing the hydrogen storage material.

2. Description of the Related Art

In recent years, there has been vigorous competition in developing polymer electrolyte fuel cells to be mounted on fuel cell vehicles. To put such polymer electrolyte fuel cells into practical use, an efficient hydrogen storage method is desired which uses a lightweight hydrogen storage material low in cost and high in hydrogen storage density.

Hydrogen storage methods using carbon materials are in particular actively studied. As the carbon materials, activated carbon, graphite intercalation compounds (GIC), single-walled carbon nanotubes (SWNT), multiwalled carbon nanotubes (MWNT), graphite nanofibers (GNF), and fullerenes are known. These carbon materials still have problems in storage and release properties at room temperature, manufacturing costs, productivity, and yield, but further study has been ongoing to overcome the problems.

A hydrogen storage method using carbon nanotubes as the carbon material has especially drawn attention for high hydrogen storage capacity thereof. There has been a report that the hydrogen storage capacity of carbon nanotubes is about 10% by weight, which suggests the possibility of achieving extremely high hydrogen storage capacity. This value of carbon nanotubes is extremely high in comparison with the hydrogen storage capacity of a hydrogen storage alloy considered to be able to store hydrogen at high density, which is about 2% by weight.

Among the carbon nanotubes, a single-walled carbon nanotube is columnar material in which a layer of graphite (graphene sheet) constituted by continuous six-membered rings of carbon atoms is rolled up, and has a diameter ranging from about 1 nm to about several tens nm and a length of not less than several hundreds nm. The single-walled carbon nanotubes are known to form a bundle structure. The single-walled carbon nanotubes are considered to store hydrogen by physically adsorbing a number of hydrogen molecules since a strong physical potential acts inside the tubes or between the tubes. On the other hand, a multiwalled carbon nanotube has a structure in which a plurality of graphene sheets are concentrically layered at regular intervals, and a sidewall of the tube is multilayered. Therefore, the ratio of surface carbon atoms brought in contact with hydrogen molecules is lowered. However, the multiwalled carbon nanotubes are expected to have high hydrogen storage capacity when hydrogen goes into the spaces between the multilayered graphene sheets.

### SUMMARY OF THE INVENTION

However, the lengths of conventional carbon nanotubes reach several hundreds nm or more immediately after being synthesized. In addition, most of the carbon nanotubes have a structure with closed ends, and therefore the internal spaces of the tubes cannot be efficiently utilized.

A result of simulation using a computer predicts that single-walled carbon nanotubes can store about 1% by weight hydrogen at room temperature by storing hydrogen inside the tubes (see Q. Wang and J. K. Johnson, J. Phys. Chem. B103, 4809-4813 (1999)). However, the hydrogen storage capacity of actual high purity single-walled carbon nanotubes remains at about 0.3% by weight (see A. Zuttel, et al., J. Alloy. Comp., 330-332, 676-682 (2002)), and plenty of space included in single-walled carbon nanotubes has not been able to be efficiently used as hydrogen storage space.

Therefore, an object of the present invention is to provide a hydrogen storage material with high hydrogen storage capacity, which uses a carbon material represented by carbon nanotubes, by efficiently utilizing internal space thereof, and to provide a method of manufacturing the hydrogen storage material. Another object of the present invention is to provide a hydrogen storage body, a hydrogen storage device, and a fuel cell vehicle using the hydrogen storage material excellent in hydrogen storage capacity.

The first aspect of the present invention provides a hydrogen storage material, comprising: a molecule including space formed with a planar sheet constituted by six-membered rings of carbon atoms, wherein at least one opening is formed in the sheet.

The second aspect of the present invention provides a method of manufacturing a hydrogen storage material, comprising: producing a molecule including space formed with a planar sheet constituted by six-membered rings of carbon atoms; and performing an opening preparation process on the molecule.

The third aspect of the present invention provides a hydrogen storage body, comprising: a hydrogen storage material comprising a molecule including space formed with a planar sheet constituted by six-membered rings of carbon atoms, wherein at least one opening is formed in the sheet.

The fourth aspect of the present invention provides a hydrogen storage device, comprising a hydrogen storage body including a hydrogen storage material comprising a molecule including space formed with a planar sheet constituted by six-membered rings of carbon atoms, wherein at least one opening is formed in the sheet.

The fifth aspect of the present invention provides a fuel cell vehicle, comprising: a hydrogen storage device including a hydrogen storage body having a hydrogen storage material, the hydrogen storage material comprising: a molecule including space formed with a planar sheet constituted by six-membered rings of carbon atoms, wherein at least one opening is formed in the sheet.

### BRIEF DESCRIPTION OF THE DRAWINGS

The invention will now be described with reference to the accompanying drawings wherein;

FIG. 1 is a laser Raman spectrum of a hydrogen storage material of the present invention;

FIG. 2 is a table showing results of hydrogen storage capacity measurement and results of laser Raman spectroscopic measurement for examples and comparative examples of the hydrogen storage material according to the present invention;

FIG. 3 is an enlarged view showing the hydrogen storage material of Example 1;

FIG. 4 is a schematic view showing the hydrogen storage material of Example 1;

FIG. 5 is an enlarged view showing the hydrogen storage material of Comparative Example 1;

FIG. 6 is a graph showing relationships between hydrogen storage capacities of the hydrogen storage materials according to the present invention in an ordinate axis and R values calculated by laser Raman spectroscopic measurement in an abscissa axis;

FIG. 7 is a graph showing relationships between hydrogen pressures and hydrogen storage capacities of the examples and one of the comparative examples;

FIG. 8 is a cross-sectional view showing an embodiment of a hydrogen storage device according to the present invention; and

FIG. 9 is a side view showing an embodiment of a fuel cell vehicle according to the present invention.

### DETAILED DESCRIPTION OF THE PREFERRED EMBODIMENT

Hereinafter, based on embodiments, detailed descriptions will be given of a hydrogen storage material, a hydrogen storage body, a hydrogen storage device, a fuel cell vehicle, and a method of manufacturing the hydrogen storage material according to the present invention. It should be noted that the drawings are schematic, and the length and aspect ratio of each tube are different from those of actual one.

(Hydrogen Storage Material)

A description will be given of an embodiment of the hydrogen storage material according to the present invention. The hydrogen storage material according to this embodiment contains molecules, each including a space formed with a planar sheet which is constituted by six-membered rings of carbon atoms, and is characterized in that at least one opening is formed in the sheet. Specifically, the hydrogen storage material contains molecules in each of which a space is formed with a sheet constituted by six-membered rings of carbon atoms, and the opening is prepared onto the hydrogen storage material which is generally difficult for hydrogen to enter, whereby hydrogen can be easily taken in the hydrogen storage material.

Moreover, the opening of the hydrogen storage material of the present invention is larger than each six-membered ring of carbon atoms. A conventional hydrogen storage material constituted by carbon atoms has difficulty storing hydrogen inside the material since a hydrogen molecule is larger in size than an opening at the center of each six-membered ring of carbon atoms. However, the hydrogen storage material of the present invention is structured so as to have the opening larger than each six-membered ring of carbon atoms. Accordingly, hydrogen molecules can easily enter the inside of the hydrogen storage material, and hydrogen can be efficiently stored.

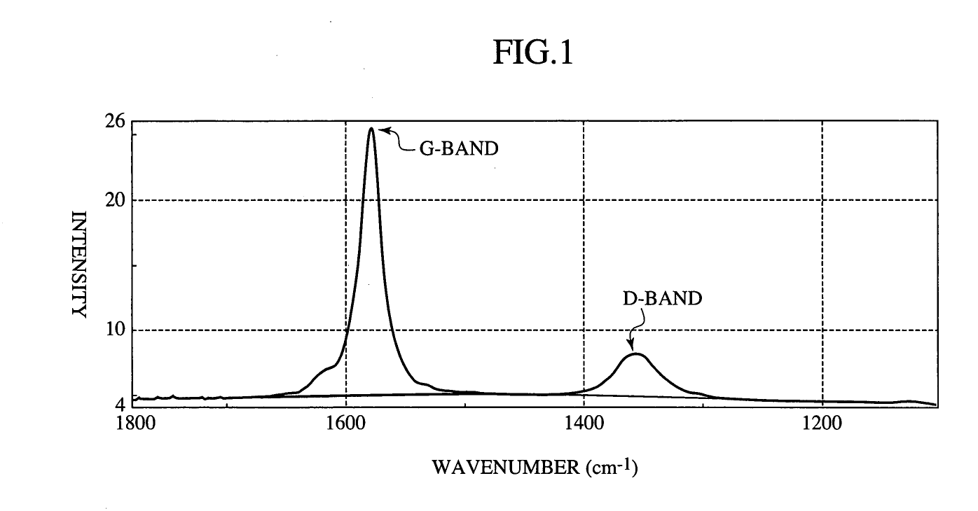

The number of the openings in the hydrogen storage material can be determined by laser Raman spectroscopic analysis. Specifically, it is preferable that the hydrogen storage material of the present invention has an R value of not less than 0.02 and not more than 0.10. Herein, the R value indicates a ratio (Id/Ig) of a spectral integrated intensity (Id) of D band to a spectral integrated intensity (Ig) of G band, which can be obtained by the laser Raman spectroscopic analysis. The hydrogen storage material with an R value of less than 0.02 has a few openings thereon, and it is difficult to allow hydrogen to efficiently enter the inside of the hydrogen storage material. The hydrogen storage material with an R value of more than 0.10 has too many openings thereon. Accordingly, the number of hydrogen storage positions in the hydrogen storage material is reduced, and the hydrogen storage material cannot efficiently store hydrogen. Herein, the laser Raman spectroscopic measurement is widely used for examining a structure of a carbon material such as graphite, diamond, fullerene, or carbon nanotubes. As shown in FIG. 1, in the spectrum of the carbon material obtained by the laser Raman spectroscopic measurement, a Raman peak derived from a graphite structure, which is called as the G band, appears in the vicinity of 1580 cm⁻¹. When the graphite structure is distorted, a Raman peak derived from an amorphous structure, which is called as the D band, appears in the vicinity of 1360 cm⁻¹. The ratio (Id/Ig) of integrated intensities of the G and D bands is referred to as the R value and widely known as a parameter showing distortion of the graphite structure. That is, the preparation of such openings that the R value is not less than 0.02 and not more than 0.10 enables efficient utilization of the internal space of the hydrogen storage material which uses a carbon material represented by carbon nanotubes, whereby the hydrogen storage material with high hydrogen storage capacity can be realized.

The hydrogen storage material used in the present invention contains columnar or prismatic molecules, each having the sheet as its sidewall, and is characterized in that openings are formed on end portions or the sidewalls of the molecules. As such columnar or prismatic molecules, single-walled carbon nanotubes or multiwalled carbon nanotubes can be utilized.

(Method of Manufacturing Hydrogen Storage Material)

Next, a description will be given of a method of manufacturing the hydrogen storage material according to the present invention.

The method of manufacturing the hydrogen storage material includes a first step of producing a molecule including space formed by a planar sheet which is constituted by six-membered rings of carbon atoms, and a second step of performing a opening preparation process on the molecule produced in the first step.

The first step can employ any one of a CVD method, a laser ablation method, an arc discharge method, a template method, a pyrolysis method, and a HiPCO™ method. After producing the molecule in the first step, purification may be performed for removing by-products, catalyst metals, and the like.

The second step is an oxidation treatment to prepare openings onto the molecule produced in the first step. The oxidation treatment can use a liquid containing at least one of nitric acid, sulfuric acid, hydrochloric acid, and a hydrogen peroxide solution. Specifically, the molecule produced in the first step, such as a carbon nanotube, is put into the above oxidative liquid and stirred. Subsequently, the oxidative liquid is removed to obtain the hydrogen storage material of the present invention which has openings thereon.

Alternatively, the second step of performing the opening preparation process on the molecule can use an oxidative gas. Specifically, the molecule produced in the first step, such as a carbon nanotube, is put in the above oxidative gas and held for a predetermined period of time. Subsequently, the oxidative gas is removed to obtain the hydrogen storage material of the present invention which has openings thereon. In this case, a gas containing at least one of air, oxygen, ozone, chlorine dioxide, chlorine, bromine, iodine, a nitrogen oxide, and a sulfur oxide can be used.

A method of producing the hydrogen storage material is within the scope of the present invention, in which the final form is adjusted by performing the second step of providing at least one opening in the end portion or the sidewall of the produced molecule after the first step or by performing a process to prepare such openings that the R value obtained by laser Raman spectroscopic analysis is not less than 0.02 and not more than 0.10.

Hereinafter, a description will be given of examples of the hydrogen storage material according to the present invention. In these examples, the availabilities of the hydrogen storage materials according to the present invention were examined, where single-walled carbon nanotubes (hereinafter, referred to as SWNT) were subjected to different processes.

### EXAMPLE 1

SWNT with a diameter of about 1 nm, produced by Carbon Nanotechnologies Inc. (CNI) in the US using the HiPCO™ method, was used as a raw material. First, 0.7 g of the SWNT was weighed and put into 200 ml of a concentrated nitric acid solution. The mixture was stirred with a stirrer at a rotational speed of about 800 rpm for 12 hours, whereby oxidation treatment was performed. After the obtained solution was subjected to suction filtration, the substance filtered out was rinsed with purified water and dried, thus obtaining Sample 1.

### EXAMPLE 2

The same SWNT, produced by CNI in the US, as the above Example 1 was used as a raw material. After the concentrated nitric acid solution was removed similarly to the above Example 1, the substance filtered out was heated under vacuum at 300° C. for three hours, thus obtaining Sample 2.

### EXAMPLE 3

The same SWNT, produced by CNI in the US, as the above Examples 1 and 2 was used as a raw material. The SWNT was weighed to be 0.7 g and put into 200 ml of a hydrogen peroxide solution. The mixture was stirred with a stirrer at a rotational speed of about 800 rpm for 12 hours, whereby oxidation treatment was performed. After the obtained solution was subjected to suction filtration, the substance filtered out was rinsed with purified water and dried, thus obtaining Sample 3.

### COMPARTIVE EXAMPLES

Comparative Example 1 was unprocessed SWNT. Comparative Example 2 was obtained in such a manner that SWNT was immersed in ethanol at room temperature for 12 hours and dried. Comparative Example 3 was obtained in such a manner that SMNT was immersed in a mixed solution of concentrated nitric acid and concentrated sulfuric acid at 70° C. for seven hours and dried. Comparative Example 4 was obtained by heating the sample of Comparative Example 3 under vacuum at 300° C. for three hours.

Sample observation was carried out using a transmission electron microscope (TEM). Each sample for observation was prepared as follows. After the sample powder was dispersed in an acetone solution, the solution with the sample powder dispersed was dropped on a copper mesh grid and then dried, thus obtaining the sample for observation.

The hydrogen storage capacity was measured as follows. Each sample of the examples and comparative examples was weighed and put into a sample tube for measurement. Subsequently, hydrogen pressure is raised to 12 MPa at room temperature after vacuum pumping, and the amount of stored hydrogen was checked. Thereafter, the hydrogen pressure was reduced to atmospheric pressure, and the amount of released hydrogen was checked.

For the laser Raman spectroscopic measurement, a laser Raman spectrophotometer NR-1800 produced by JASCO Corp. was used. The measurement was carried out under conditions of an excitation wavelength of 515.4 nm (Ar), an output power of 95-96 mW, and a laser beam irradiated diameter of about 1 mm. The measurement time was 0.15 to 0.17 second×1000 to 4800 times.

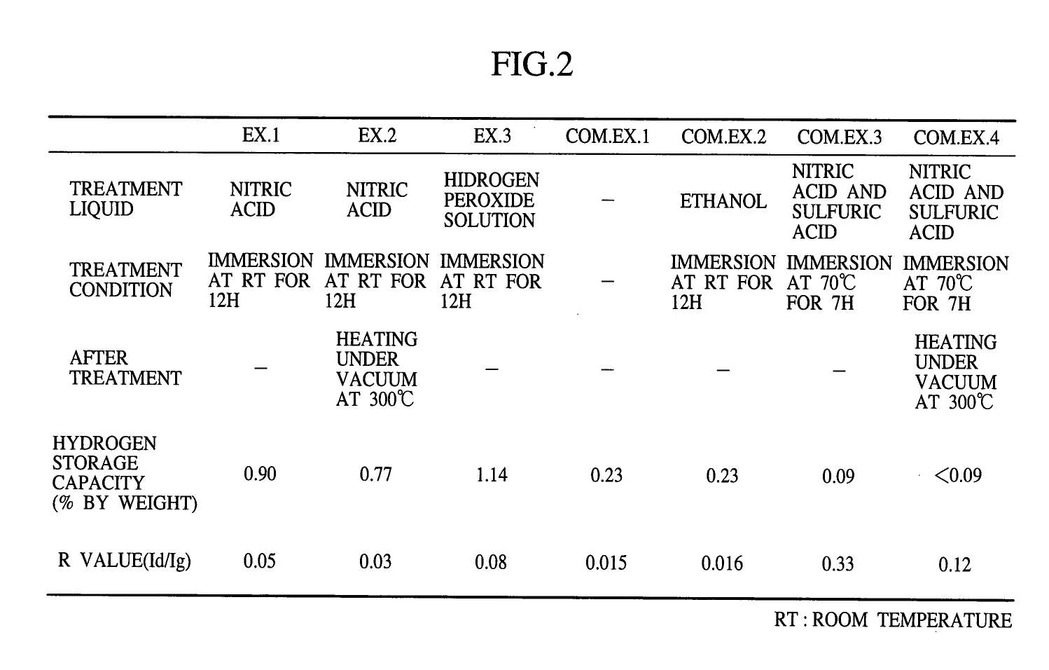

Results of the hydrogen storage capacity measurement and of the laser Raman spectroscopic measurement of Examples 1 to 3 and Comparative Examples 1 to 4 are shown in FIG. 2. Herein, Examples 1 to 3 are samples prepared so as to be within the scope of claims of the present invention. Specifically, each of the samples was processed such that the R value became not less than 0.02 and not more than 0.10.

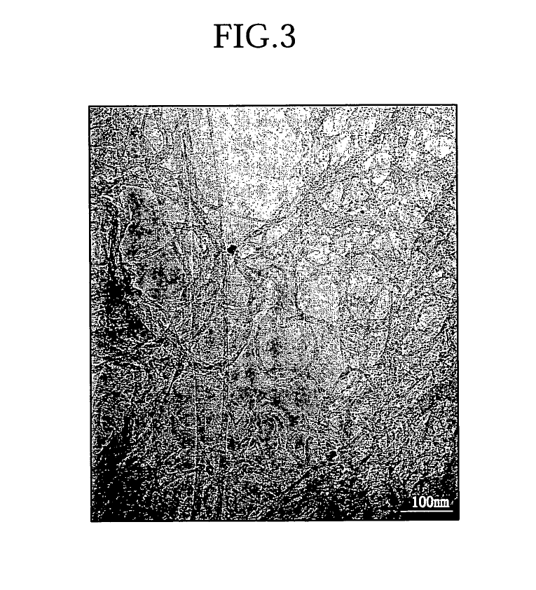

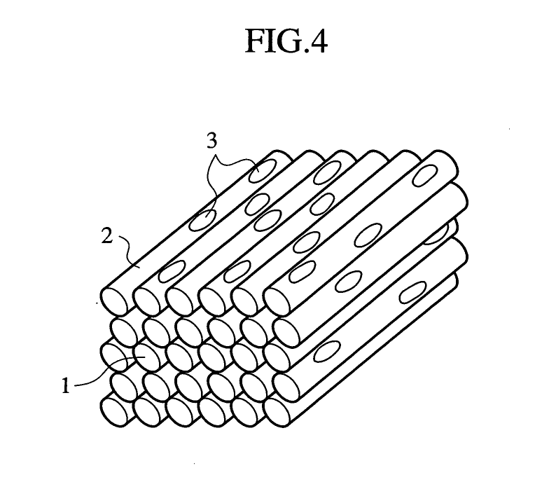

A result of the TEM observation of Example 1 is shown in FIG. 3. As observed in FIG. 3, the surface of the SWNT was not smooth with inequality caused, and innumerable openings were observed. In addition, it was confirmed that part of the SWNT had a structure of multiwalled carbon nanotubes (hereinafter, referred to as MWNT) or amorphous carbon. With this process, as schematically shown in FIG. 4, it was confirmed that a number of openings 3 were prepared onto the surface of the bundle of SWNT 1, and the sidewalls 2 of the SWNT were partially opened. At this time, the R value of Example 1 by the laser Raman spectroscopic measurement was about 0.05. The hydrogen storage capacity of Example 1 reached 0.90% by weight, which showed that Example 1 was improved to have three times or more the hydrogen storage capacity of the unprocessed SWNT (Comparative Example 1).

As for Example 2, the R value was about 0.03, which was slightly lower than that of the above Example 1. The hydrogen storage capacity of Example 2 reached 0.77% by weight, which showed that high hydrogen storage capacity was maintained.

As a result of the TEM observation of Example 3, similarly to the above Example 1, a number of openings were observed on the surface of the bundle, and the sidewalls of the SWNT were confirmed to be partially opened. The R value of Example 3 was about 0.08. The hydrogen storage capacity thereof reached 1.14% by weight, which showed similarly to the above Examples 1 and 2 that the hydrogen storage capacity was significantly increased in comparison with the unprocessed SWNT.

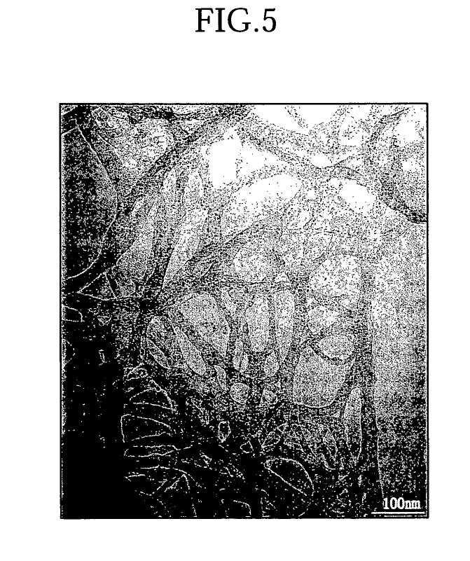

A result of the TEM measurement of Comparative Example 1 is shown in FIG. 5. As the result of the TEM measurement, it was confirmed that several tens to several hundreds of SWNT were bundled to form a bundle of about 10 to 100 nm. The sidewalls of the SWNT in Comparative Example 1 were smooth, and few openings were observed. At this time, the R value thereof by the laser Raman spectroscopic measurement was about 0.015. The hydrogen storage capacity of Comparative Example 1 was 0.23% by weight.

As a result of the TEM measurement of Comparative Example 2, a bundle structure substantially the same as that of Comparative Example 1 was observed, and few openings were observed. The R value thereof by the laser Raman spectroscopic measurement was about 0.016, which was substantially the same as that of Comparative Example 1. The hydrogen storage capacity of Comparative Example 2 was 0.23% by weight, which was not increased. Accordingly, it was found that only immersing the SWNT into ethanol was insufficient.

As a result of the TEM observation of Comparative Example 3, innumerable openings were observed in the SWNT, and it was confirmed that part of the SWNT formed a structure of MWNT or amorphous carbon. In Comparative Example 3, the R value by the laser Raman spectroscopic measurement was significantly increased to about 0.33. However, the hydrogen storage capacity was significantly reduced in comparison with that of Comparative Example 1 to about 0.09% by weight.

The R value of Comparative Example 4 by the laser Raman spectroscopic measurement was reduced to about 0.12 due to the heating process under vacuum, but the hydrogen storage capacity thereof was not increased and not more than 0.09% by weight.

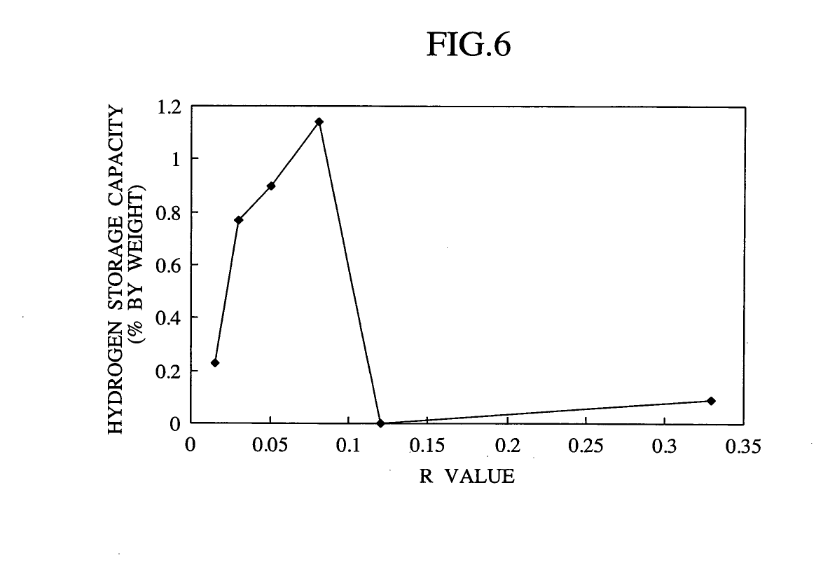

The aforementioned results are shown in FIG. 6. FIG. 6 is a graph showing relationships between the hydrogen storage capacities at 12 MPa in the ordinate axis and the R values calculated by the laser Raman spectroscopic measurement in the abscissa axis for the hydrogen storage materials obtained by Examples 1 to 3 and Comparative Examples 1 to 4.

FIG. 6 shows improvement in the hydrogen storage capacities of the samples which were processed so as to have R values of not less than 0.02 and not more than 0.10, and shows that the hydrogen storage capacities are high especially in the cases of the R values of not less than 0.03 and not more than 0.08.

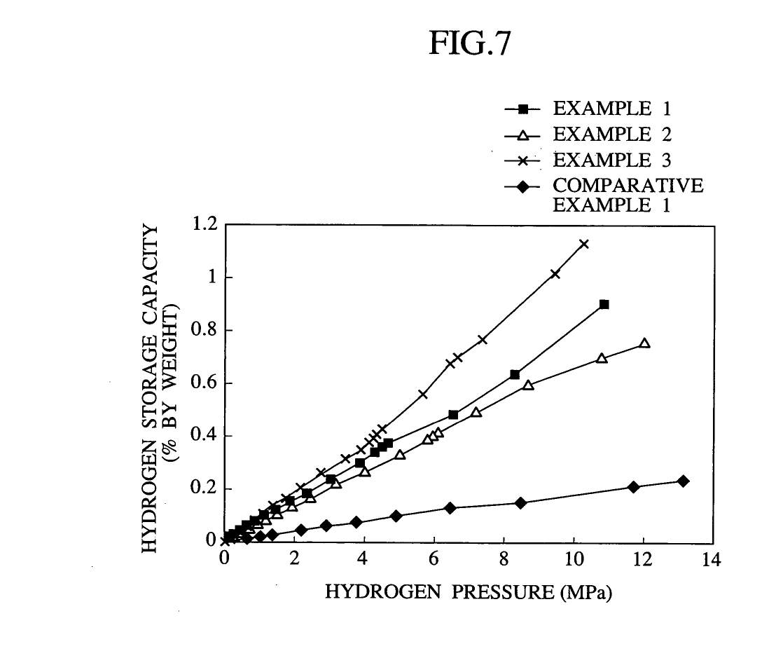

FIG. 7 is a graph showing pressure dependency of the hydrogen storage capacities of Examples 1 to 3 and Comparative Example 1. Comparative Examples 2 and 3 are eliminated because Comparative Examples 2 and 3 were out of the scope of claims, in other words, Comparative Examples 2 and 3 were processed so as to have R values of less than 0.02 or more than 0.10. In FIG. 7, each of Examples 1 to 3 shows good hydrogen storage capacity even in a region with low hydrogen pressure and shows good hydrogen storage capacity under any hydrogen pressure.

(Hydrogen Storage Body and Hydrogen Storage Device)

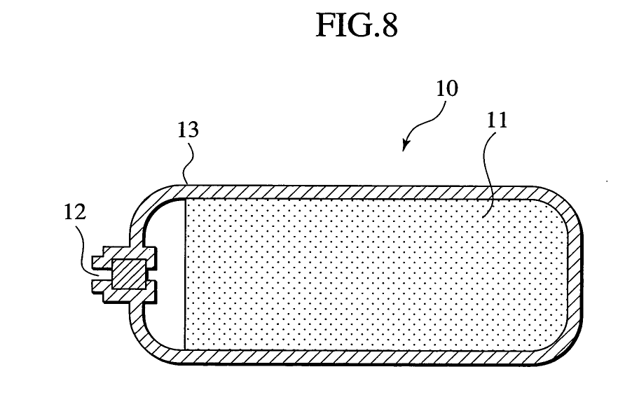

FIG. 8 shows an embodiment of the hydrogen storage device to be mounted on a vehicle according to the present invention. This hydrogen storage device 10 includes a hydrogen storage body 11. The hydrogen storage body 11 is directly formed of the powdery hydrogen storage material of the present invention, or is formed by solidifying the hydrogen storage material of the present invention or forming a thin film from the same by compression molding. The hydrogen storage body 11 is encapsulated in a pressure-resistant container 13 provided with a hydrogen outlet 12. The hydrogen storage device 10 thus structured may be mounted on a vehicle and incorporated in a fuel cell system to be used. The container may have a structure provided with a lib or a pillar inside as well as a structure including a simple closed space. Such the structure enables the hydrogen storage device to be reduced in size and weight. Moreover, it is possible to reduce installation space and vehicle weight when the hydrogen storage device with such a structure is mounted on a vehicle.

(Fuel Cell Vehicle)

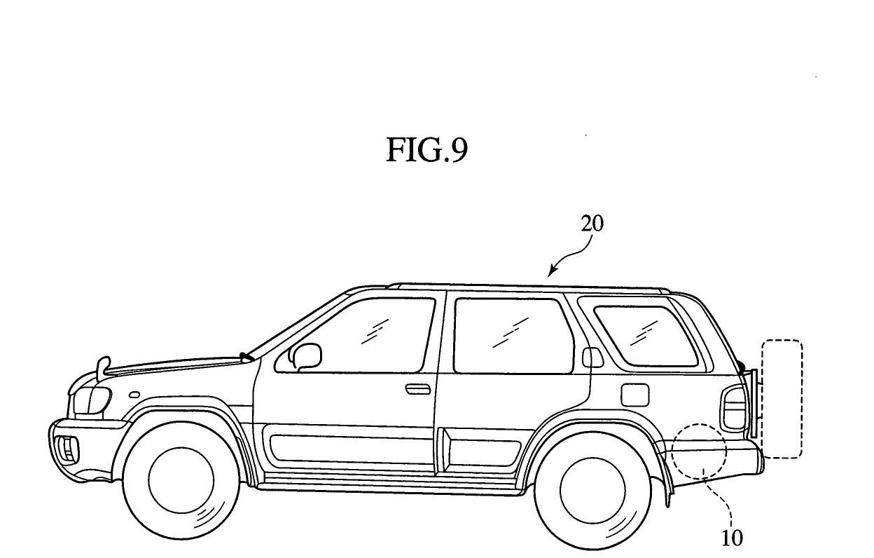

FIG. 9 shows an embodiment of a fuel cell vehicle on which the hydrogen storage device according to the present invention is mounted. In a fuel cell vehicle 20 of the present invention, the hydrogen storage device 10 shown in FIG. 8 is mounted and installed. At this time, the hydrogen storage device 10 may be mounted and installed in one piece or may be separated into a plurality of hydrogen storage devices, and each of the hydrogen storage devices may have different shapes. The hydrogen storage device 10 may be installed inside the vehicle such as in an engine room, a trunk room, or a floor section under seats, as well as outside the vehicle such as on the upper potion of a roof. Using the hydrogen storage material of the present invention, vehicle weight is reduced in comparison with the case of using a conventional hydrogen storage alloy, therefore fuel saving can be achieved, and an effect such as an increase in driving range can be obtained. Moreover, since the volume of a storage system can be reduced, it is possible to obtain an effect such as availability of wider vehicle interior space.

The entire content of a Japanese Patent Application No. P2003-85515 with a filing date of Mar. 26, 2003 is herein incorporated by reference.

Although the invention has been described above by reference to certain embodiments of the invention, the invention is not limited to the embodiments described above will occur to these skilled in the art, in light of the teachings. The scope of the invention is defined with reference to the following claims.

What is claimed is:

1. A hydrogen storage material, comprising:
a molecule including space formed with a planar sheet constituted by six-membered rings of carbon atoms,
wherein at least one opening is formed in the sheet.

2. The hydrogen storage material of claim 1,
wherein the molecule is a columnar or prismatic molecule having the sheet as a sidewall, and
the opening is formed in any one of an end portion and the sidewall of the molecule.

3. The hydrogen storage material of claim 1,
wherein the opening is larger than one of the six-membered rings of carbon atoms.

4. The hydrogen storage material of claim 1,
wherein an R value of the hydrogen storage material is not less than 0.02 and not more than 0.10, the R value indicating a ratio of a spectral integrated intensity of D band to a spectral integrated intensity of G band, the spectral integrated intensities being obtained by laser Raman spectroscopic analysis.

5. The hydrogen storage material of claim 1,
wherein the molecule is a single-walled carbon nanotube or a multiwalled carbon nanotube.

6. A method of manufacturing a hydrogen storage material, comprising:
producing a molecule including space formed with a planar sheet constituted by six-membered rings of carbon atoms; and
performing an opening preparation process on the molecule.

7. The method of manufacturing a hydrogen storage material of claim 6,
wherein the molecule is a columnar or prismatic molecule having the sheet as a sidewall.

8. The method of manufacturing a hydrogen storage material of claim 6,
wherein the opening preparation process is oxidation treatment.

9. The method of manufacturing a hydrogen storage material of claim 8,
wherein the oxidation treatment uses at least one of nitric acid, sulfuric acid, hydrochloric acid, and a hydrogen peroxide solution.

10. The method of manufacturing a hydrogen storage material of claim 8,
wherein the oxidation treatment uses an oxidative gas.

11. The method of manufacturing a hydrogen storage material of claim 10,
wherein the oxidative gas contains at least one of air, oxygen, ozone, chlorine dioxide, chlorine, bromine, iodine, a nitrogen oxide, and a sulfur oxide.

12. A hydrogen storage body, comprising:
a hydrogen storage material containing a molecule including space formed with a planar sheet constituted by six-membered rings of carbon atoms,
wherein at least one opening is formed in the sheet.

13. A hydrogen storage device, comprising
a hydrogen storage body including a hydrogen storage material
the hydrogen storage material comprising:
a molecule including space formed with a planar sheet constituted by six-membered rings of carbon atoms,
wherein at least one opening is formed in the sheet.

14. A fuel cell vehicle, comprising:
a hydrogen storage device including a hydrogen storage body having a hydrogen storage material,
the hydrogen storage material comprising:
a molecule including space formed with a planar sheet constituted by six-membered rings of carbon atoms,
wherein at least one opening is formed in the sheet.
